(19) United States
(12) Patent Application Publication
(10) Pub. No.: US 2016/0217578 A1
(43) Pub. Date: Jul. 28, 2016

(54) SYSTEMS AND METHODS FOR MAPPING SENSOR FEEDBACK ONTO VIRTUAL REPRESENTATIONS OF DETECTION SURFACES

(71) Applicant: Red Lotus Technologies, Inc., Mountain View, CA (US)

(72) Inventors: Matthew Can, Glendora, CA (US); Lahiru Jayatilaka, Palo Alto, CA (US)

(73) Assignee: RED LOTUS TECHNOLOGIES, INC., Mountain View, CA (US)

(21) Appl. No.: 14/254,470

(22) Filed: Apr. 16, 2014

Related U.S. Application Data
(60) Provisional application No. 61/812,475, filed on Apr. 16, 2013.

(51) Int. Cl. G06T 7/00; G08C 23/02; G06T 11/60; G01C 3/00; G01C 19/5698; G06T 17/05; G08C 23/04; G08C 23/00

(52) U.S. Cl. CPC G06T 7/0042; G08C 23/04; G08C 23/02; G08C 23/00; G01C 3/00; G01C 19/5698; G06T 17/05; G06T 11/60; H04M 2250/10; G06T 2207/10044; G06T 2207/10048; G06T 2207/30212

(57) ABSTRACT

Systems and methods for mapping sensor feedback onto virtual representations of detection surfaces are disclosed herein. A system configured in accordance with an embodiment of the present technology can, for example, record and process feedback from a sensing device (e.g., a metal detector), record and process user inputs from a user input device (e.g. user-determined locations of disturbances in the soil surface), determine the 3D position, orientation, and motion of the sensing device with respect to a detection surface (e.g., a region of land being surveyed for landmines) and visually integrate captured and computed information to support decision-making (e.g. overlay a feedback intensity map on an image of the ground surface). In various embodiments, the system can also determine the 3D position, orientation, and motion of the sensing device with respect to the earth's absolute coordinate frame, and/or record and process information about the detection surface.

### CROSS-REFERENCE TO RELATED APPLICATION(S)

This application claims the benefit of U.S. Provisional Application No. 61/812,475, entitled “Systems and Methods for Mapping Sensor Feedback onto Virtual Representations of Detection Surfaces,” filed Apr. 16, 2013, which is incorporated herein by reference for all purposes in its entirety.

### STATEMENT REGARDING FEDERALLY SPONSORED RESEARCH OR DEVELOPMENT

This technology was made with government support under Award No. W911NF-07-2-0062 from a Cooperative Agreement with the United States Army Research Laboratory. The government has certain rights in this invention.

### TECHNICAL FIELD

The present technology is directed generally to systems and methods for mapping sensor feedback onto virtual representations of detection surfaces.

### BACKGROUND

Landmines are passive explosive devices hidden beneath topsoil. During armed conflict, landmines and other improvised explosive devices (IEDs) can be used to deny access to military positions or strategic resources, and/or to inflict harm on an enemy combatant. Unexploded landmines can remain after the end of the conflict and result in civilian injuries or casualties. The presence of landmines can also severely inhibit economic growth by rendering large tracts of land useless to farming and development.

The act of demining can be performed during and/or after conflict and is aimed to mitigate these problems by finding landmines and removing them before they can cause damage. Typical demining approaches include sending human operators (e.g., military personnel or humanitarian groups, i.e., “deminers”) into the field with handheld detectors (e.g. metal detectors) to identify the position of the landmines. When using a handheld detector, a deminer's tasks include (a) identifying and clearing an area on the ground, (b) sweeping the area with the metal detector, (c) detecting the presence of a landmine in the area (e.g., identifying the location of the landmine in the area), and (d) investigating the area using a prodder or excavator.

A significant component of deminer training involves human operators practicing with a handheld detector on defused (or simulant) targets in indoor/outdoor conditions.

### BRIEF DESCRIPTION OF THE DRAWINGS

FIG. 1 is a block diagram of a system for mapping sensor feedback onto a virtual representation of a detection surface in accordance with an embodiment of the present technology.

FIG. 2 is a block diagram of a system component for recording, processing, and communicating data to map sensor feedback onto a virtual representation of a detection surface in accordance with an embodiment of the present technology.

FIG. 3 is a block diagram of a system configured to use ultrasound-based position tracking for determining the relative position, orientation, motion, and heading of a sensing device with respect to a detection surface in accordance with an embodiment of the present technology.

FIG. 4 is a block diagram of a system configured to use Global Positioning System (GPS)-based position tracking for determining the relative position, orientation, motion, and heading of a sensing device with respect to a detection surface and with respect to the earth's coordinate frame in accordance with an embodiment of the present technology.

FIG. 5 is a schematic diagram of a system configured to use ultrasound-based position tracking for determining the relative position, orientation, motion, and heading of a sensing device with respect to a detection surface in accordance with an embodiment of the present technology.

### DETAILED DESCRIPTION

The present technology is directed to systems and methods for providing visual-decision support in subsurface object sensing. In several embodiments, for example, systems and methods for visual-decision support in subsurface object sensing can be used for one or more of the following: (i) determining the pose (including at least some of 3D position, orientation, heading, and motion) of a sensing device with respect to a detection surface and/or the earth's coordinate frame; (ii) collecting information about a detection surface during investigation activity; (iii) visual mapping and visual integration of sensor feedback and detection surface information; (iv) capturing and visually mapping user input actions during investigation activity; and (v) providing visual-decision support to multiple users and across multiple sensing devices such as during training activities.

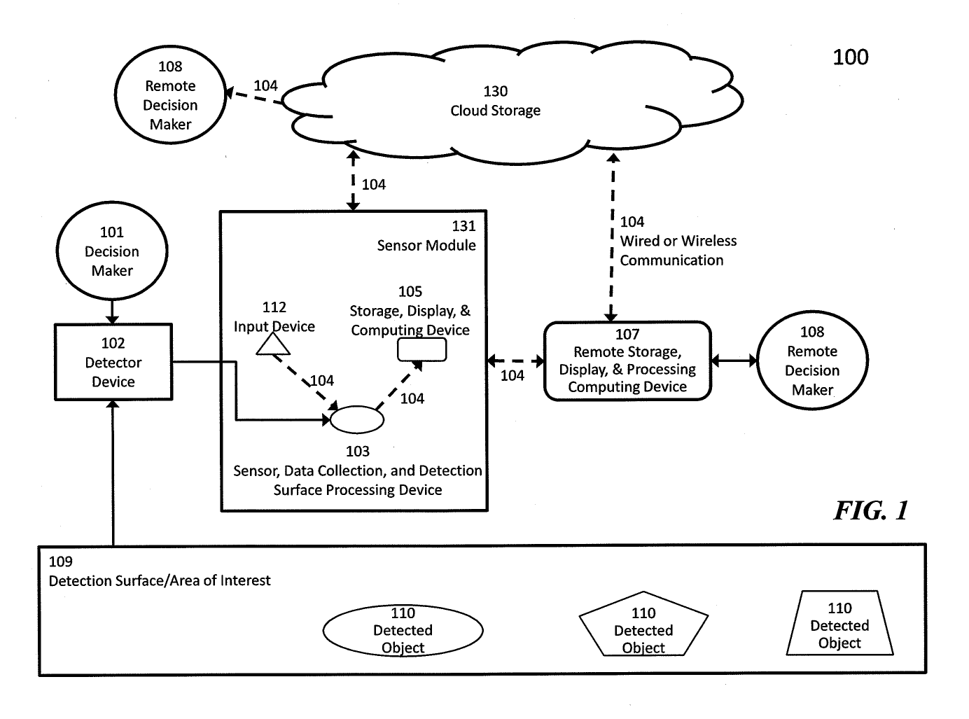

Certain specific details are set forth in the following description and in FIGS. 1-5 to provide a thorough understanding of various embodiments of the technology. For example, many embodiments are described below with respect to detecting landmines and IEDs. In other applications and other embodiments, however, the technology can be used to detect other subsurface structures and/or in other applications. For example, the methods and systems presented can be used in non-invasive medical sensing (e.g., portable ultrasound and x-ray imaging) to combine image data captured at different spatial points on a human or animal body. Other details describing well-known structures and systems often associated with detecting subsurface structures have not been set forth in the following disclosure to avoid unnecessarily obscuring the description of the various embodiments of the technology. Many of the details, dimensions, angles, and other features shown in the Figures are merely illustrative of certain embodiments of the technology. A person of ordinary skill in the art, therefore, will accordingly understand that the technology may have other embodiments with additional elements, or the technology may have other embodiments without several of the features shown and described below with reference to FIGS. 1-5.

### A. Overview

The present technology is directed to subsurface object sensing, such as finding explosive threats (e.g., landmines) buried under the ground using an above-ground mobile detector. In several embodiments, for example, the technology includes systems and methods for recording, storing, visualizing, and transmitting augmented feedback from these sensing devices. In certain embodiments, the technology provides systems and methods for mapping sensor feedback onto a virtual representation of a detection surface (e.g., the area undergoing detection). In various embodiments, the systems and methods disclosed herein can be used in humanitarian demining efforts in which a human operator (i.e., a deminer) can use a handheld metal detector and/or a metal detector (MD) with a ground penetrating radar (GPR) sensor to detect the presence of an explosive threat (e.g., a landmine) that may be buried under the surface of the soil. In other embodiments, the technology disclosed herein can be used during military demining, in which a solider can use a sensing device to detect the presence of explosive threat (e.g., an IED) that may be buried under the soil surface.

Typical man-portable sensing solutions can be limited because a single operator is required to listen to and remember auditory feedback points in order to make detection decisions (e.g., Staszewski, J. (2006), In G. A. Allen, (Ed.), Applied spatial cognition: From research to cognitive technology (pp. 231-265). Mahwah, N.J.: Erlbaum Associates, which is incorporated herein by reference herein in its entirety). The present technology can visually map sensor feedback from an above-surface mobile detector onto a virtual representation of a detection surface, thereby reducing the dependence on operator memory to identify a detected object location and facilitating collective decision-making by one or more remote operators (e.g., as provided by Lahiru G. Jayatilaka, Luca F. Bertuccelli, James Staszewski, and Krzysztof Z. Gajos, In CHI '11: Proceeding of the annual SIGCHI conference on Human factors in computing systems, New York, N.Y., USA, 2011. ACM; and Takahashi, Yokota, Sato, ALIS: GPR System for Humanitarian Demining and Its Deployment in Cambodia, In Journal of The Korean Institute of Electromagnetic Engineering and Science, Vol 12, No. 1, 55˜62. March 2012, each of which are incorporated herein by reference in its entirety).

The present technology can provide accurate mapping feedback in a variety of different operating conditions (e.g., different weather conditions, surface compositions, etc.), and the mapping systems can be lightweight and portable to reduce the equipment burden to a human operator or on an autonomous sensing platform (e.g., an unmanned aerial vehicle (UAV) or ground robot). These mapping systems can also be resilient to security attacks (e.g., wireless signal jamming or unauthorized computer network security breaches).

Other efforts have been made to visually map sensor feedback in subsurface object sensing. In the area of landmine detection with handheld detectors, the advanced landmine imaging system (ALIS) maps feedback from a handheld detector using a video camera attached to sensor shaft. However, the ALIS system does not guarantee performance on detection surfaces that lack visual features (which can be critical for determining the position of the sensor head), or on detection surfaces that are poorly illuminated. The ALIS system also has a limited area that it can track and adopts a specific visualization approach: overlaying an intensity map on an image of the ground. The pattern enhancement tool for assisting landmine sensing (PETALS) is another visual feedback system that provides a specific visual feedback mechanism for mapping detector feedback onto a virtual representation of ground, but this system does not provide detailed systems and methods for tracking the position of the sensing device. In the area of training, the Sweep Monitoring System (SMS) by L3 Cyterra visually maps the position and motion of a handheld detector (at low resolution) in order to aid the assessment of operator area coverage (sweep) techniques. However, the SMS cannot visualize precise information about operator investigation technique of subsurface targets and also does not provide any information about the detection surface. Furthermore, because the SMS system relies on visual tracking of a colored marker mounted on the detector shaft, its position tracking capabilities are susceptible to similar shortcomings as the ALIS system.

Accordingly, the present technology is expected to resolve at least some of the above-mentioned drawbacks of existing systems, and some of the operational requirements for such decision support systems may be addressed through a comprehensive set of system embodiments and methods for visually mapping output from a sensor onto a virtual representation of a detection surface. For example, to track the movement of the sensing device, the present technology provides a set of position and motion tracking technologies that can work in a range of operating conditions.

### B. Selected Embodiments of Systems and Methods for Mapping Sensor Feedback

FIG. 1 is a block diagram of a system 100 for mapping sensor feedback onto a virtual representation of a detection surface in accordance with an embodiment of the present technology. In the illustrated embodiment, a user 101 (i.e., the decision-maker) may use a sensor or sensing device 102 to scan a region 109 (identified as a “detection surface”) for presence of an object 110, such as a landmine or an IED. The user 101 may be a person skilled in the use and/or operation of the sensing device 102, or may be a person in training (e.g., a trainee using the sensing device 102 to scan the region 109 to detect the presence of an object in the region 109 as part of a training exercise). As a person skilled in the art would appreciate, the technology may be adapted to help the user 101 detect various suitable types of objects and that the present technology is not limited to helping the user 101 detect a landmine or IED. In various embodiments of the technology, the user 101 may be a robotic platform (e.g., a UAV) that can move the sensing device 102 over region 109.

The sensing device 102 may be any suitable sensor for detecting the presence of an object that the user 101 seeks to detect. For example, the sensing device 102 may be a metal detector. As the user 101 moves the sensing device 102 over the region 109, the sensing device 102 may provide the user 101 with feedback to indicate the presence of an object (e.g., a metal object) in at least a portion of the region 109. The feedback provided by the sensing device 102 may be any suitable type of feedback. For example, the feedback may be acoustic feedback (e.g., the acoustic feedback provided by metal detectors).

The user 101 may use an input device 112 (e.g., a push button) to denote spatial or temporal points of interest and/or importance during the investigation process (e.g., while scanning the region 110). For example, the user 101 can use the input device 112 to indicate spatial points when feedback from the sensing device 102 reaches a threshold level (e.g., as provided by Lahiru G. Jayatilaka, Luca F. Bertuccelli, James Staszewski, and Krzysztof Z. Gajos, Evaluating a Pattern-Based Visual Support Approach for Humanitarian Landmine Clearance, in CHI '11: Proceeding of the annual SIGCHI conference on Human factors in computing systems, New York, N.Y., USA, 2011. ACM, which is herein incorporated by reference in its entirety.) and/or when the sensing device 102 travels over a region of the detection surface 109 that contains features of interest (e.g., intentional soil disturbance). Points of interest may also be indicated using voice-driven commands that are captured using a microphone 121, or may be determined algorithmically or computationally by a computing unit 120 using data processing and analysis techniques.

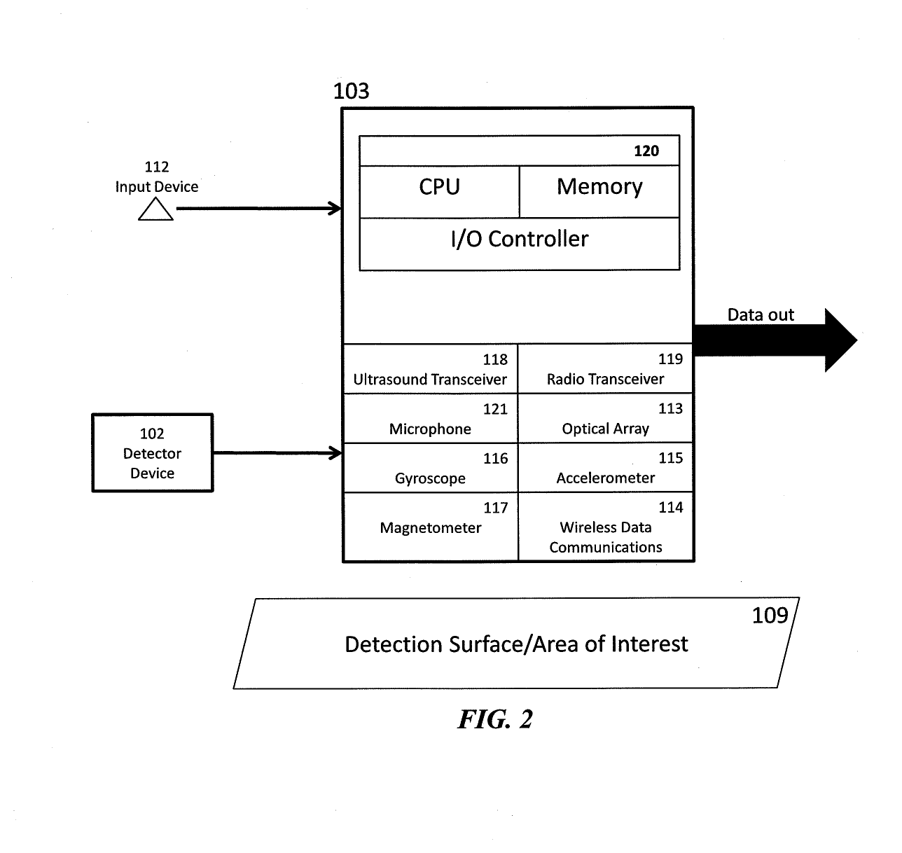

As further shown in FIG. 1, the system 100 may further include a computing device 105 (e.g., a smart phone, tablet computer, PDA, heads-up display (e.g., Google Glass™), or other display device) that is capable of displaying a visual map of feedback from the sensing device 102, providing a visualization of a detected object location which is visually integrated onto a virtual representation of the detection surface 109. The computing device 105 can also be configured to display visual indications on the map of points of interest indicated by the user 101 using the input device 112. In various embodiments, the computing device 105 can also be configured to receive, process, and store the data necessary for producing various types of visual support (described in further detail below). The computing device 105 can receive data over a wired and/or a wireless data connection 104 from a system component 103 (described in further detailed below with respect to FIG. 2).

In certain embodiments, the system 100 can also include a remote computing device 107 that has similar capabilities and functions as the computing device 105, but may be located in a remote location to provide remote viewing capabilities to a remotely located user 108. The remote user 108 may use the visualizations to offer decision support and other forms of guidance to the user 101. In some embodiments, for example, the user 101 may be an operator on the field, and the remote user 108 may be a supervisor or an expert operator located in a control room. In other embodiments, the user 101 may be an operator in training, and the remote user 108 may be an instructor providing instruction and corrective feedback to the user 101. As illustrated in FIG. 1, a remote decision maker may also access visualizations transmitted via a network or stored on a data storage facility, e.g., a cloud storage data network 130.

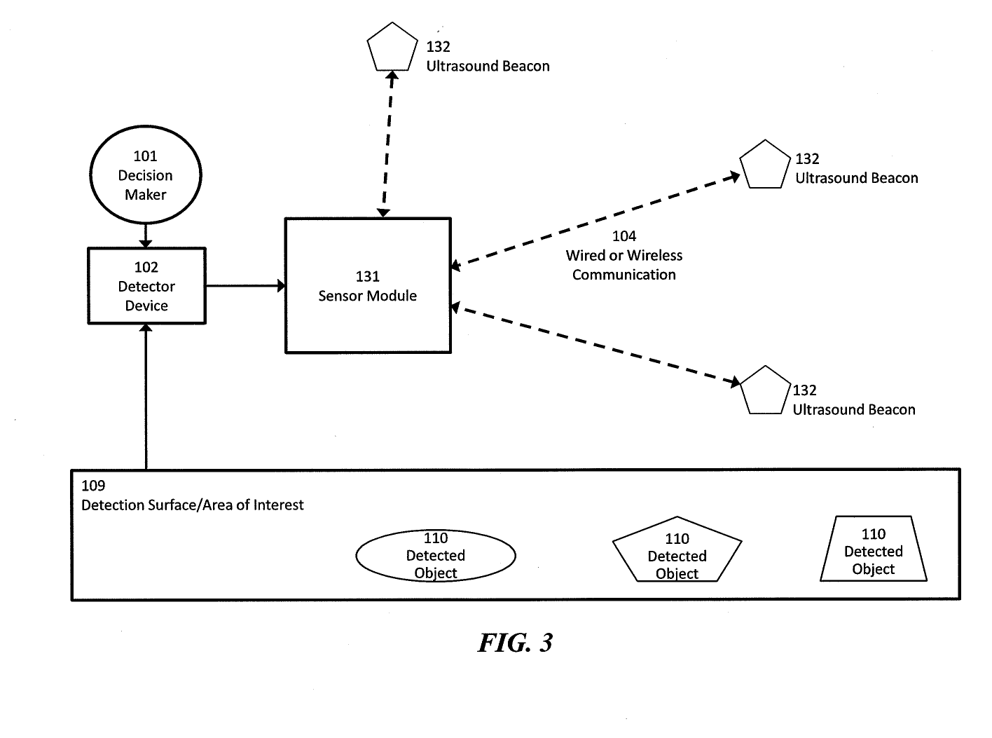

In a training context, the system 100 may also be configured for virtual training where, for example, component 107, 105, or 103 may simulate sensor feedback (e.g., simulate audio feedback from a metal detector) based on the position, motion, heading, and/or orientation of the sensing device with respect to the detection surface. As an example, a trainer may use augmented reality software and a positioning system according to the present disclosure (e.g., an ultrasound-enabled location system such as the system illustrated in FIG. 3) to place virtual targets at different locations on the floor (detection surface) of a room. The trainee, tasked with finding the targets, operates a handheld prop (e.g., a handheld sensor or a training tool resembling a handheld sensor) augmented with the system 100. As the trainee sweeps patterns across the floor, the system provides sensor feedback with respect to the virtual targets, simulating the feedback that a real handheld sensor generates for real targets.

In various aspects of the system 100, visual support information from multiple sensing devices (e.g., multiple sensing devices 102 paired with system components 103) may be monitored using the local and remote computing devices 105 and 107. In further aspects of the system 100, one sensing device (e.g., the sensing device 102) paired with one system component 103 may be monitored by multiple display devices (e.g., various remote displays).

The mapping of sensor feedback from the sensing device 102 and the input device 112 onto a virtual representation of the detection surface 109 may take on various suitable visual representations that support the decision-making processes of the user 101. For example, representations may include heat maps, contour maps, topographical maps, and/or other suitable maps or graphical representations known to those skilled in the art.

The virtual representation of the detection surface 109 may take on any number of suitable visual representations that support the decision-making processes of the user 101. For example, in various embodiments the visual representation on the computing device 105 can include two-dimensional (2D) photographic images, 2D infrared images, three-dimensional (3D) images or representations, and/or other visual representations known to those skilled in the art.

The visual integration of the sensor feedback map with the virtual representation of the detection surface 109 on the computing device 105 may take on various suitable methods that support the decision-making process of the user 101 (e.g., determining if, and where, there is a threat such as an IED or landmine; determining threat size; determining configuration such as a location of a trigger point; and/or determining the material composition of the buried threat). In certain embodiments, for example, the method of visually integrating the sensor feedback map with the virtual representation of the detection surface 109 to identify a detected object location can include point-in-area methods, line-in-area methods, and/or other suitable integration methods known to those skilled in the art.

The visual representation of sensor feedback from the sensing device 102 and/or points of interest indicated using the input device 112 may take on any number of suitable representations on the integrated map that support the decision-making process of the user 101. For example, the feedback and points of interest can be represented as discrete marks, such as dots or other small shapes (e.g. circles, rectangles, etc.), and/or other suitable types of markings or graphical icons (e.g., indicating a location of detected object or an edge or contour of a detected object).

The system component 103 can be configured to record, process, and transmit data required for generating the various types of visual feedback described above (e.g., the sensor feedback map, the virtual representation of the detection surface 109, the integration of the two, etc.). In certain embodiments, the system component 103 can (a) record and process feedback from the sensing device 102; (b) record and process user inputs from the input device 112; (c) determine the pose (including, e.g., 3D position, orientation, heading, and/or motion) of the sensing device 102 with respect to the detection surface 109; (d) determine the pose (including, e.g., 3D position, orientation, heading, and/or motion) of the sensing device 102 with respect to the earth's absolute coordinate frame; (e) record and process information about the detection surface 109; and/or (f) transmit recorded or processed data to computing devices 105, 107 or transfer data to a cloud storage data network 130. The system component 103 can create or generate the virtual representation of the detection surface 109 based on the determined pose of the sensing device 102 and the information about the detection surface 109. In the embodiment illustrated in FIG. 1, the system component 103 is a discrete device (e.g., an add-on device). In other embodiments, the system component 103 may be integrated into the sensing device 102 as part of a single integrated unit. In various embodiments, it may be necessary to calibrate/tune the sensing device 102 in order to account for the additional hardware contained in system component 103 and/or to implement software methods and installation procedures, apparent to those skilled in the art; for example, in order to account for any spatial separation between the system component 103 and a point of interest on the sensing device (e.g., a sensor head of a metal detector).

In embodiments where system component 103 is a discrete device (i.e. not integrated with sensing device 102), it can capture feedback from sensing device 102 over a wired/wireless communication channel (e.g., electrical or optical signals). In embodiments where such direct a communication link is not possible (e.g. proprietary algorithms and interfaces on the detection device), the sensor feedback may be captured using an acoustic feedback sensor such as a microphone 121 of FIG. 2.

FIG. 2 is a block diagram of a system component (e.g., the system component 103 of FIG. 1) for recording, processing, and communicating data to map sensor feedback onto a virtual representation of a detection surface in accordance with an embodiment of the present technology. The system component 103 can include one or more optical or imaging sensors such as an optical array 113 (e.g., a plurality of imaging sensors) configured to have a field of view to be able to capture photographic images of partial or full areas of the detection surface 109 during investigation activity. The recorded images may be compiled to generate a 2D or 3D photographic representation of the detection surface 109. In other embodiments, the system component 103 can include other sensors or features that can be used to gather information about the detection surface, such as an infrared camera or camera array. In certain embodiments of the technology, the optical array 113 may be used to determine the position (e.g., in 3D space), orientation, and/or motion of the sensing device 102 with respect to the detection surface 109 using visual odometry, visual simultaneous localization and mapping (SLAM), and/or other suitable positioning/orientation techniques.

As shown in FIG. 2, the system component 103 can further include inertial sensors and other pose sensors including a gyroscope 116, an accelerometer 115, and a magnetometer 117 that together or individually may be used to determine 3D position, orientation, heading, and/or motion of the sensing device 102 with respect to the detection surface and with respect to the absolute coordinate frame using various techniques, such as extended Kalman filtering (i.e., linear quadratic estimation).

FIG. 3 is a block diagram of a system configured to use ultrasound-based position tracking for determining the relative position, orientation, motion, and heading of a sensing device with respect to a detection surface in accordance with an embodiment of the present technology. In certain embodiments of the technology, the system component 103 can include an ultrasound transceiver 118 that can be used in conjunction with fixed external reference point ultrasound beacons 132 to determine 3D position, orientation, heading, and/or motion of the sensing device 102 with respect to the detection surface using, e.g., straight-line distance estimates between each beacon and the ultrasound transceiver 118. The straight-line distance may be determined using ultrasound techniques, such as time-of-flight, phase difference, etc. In some embodiments, the system component 103 includes other technology for determining 3D position, orientation, heading, and/or motion of the sensing device 102, e.g., one or more laser rangefinders, infrared cameras, or other optical sensors mounted at one or more external reference points or tracking one or more external reference points.

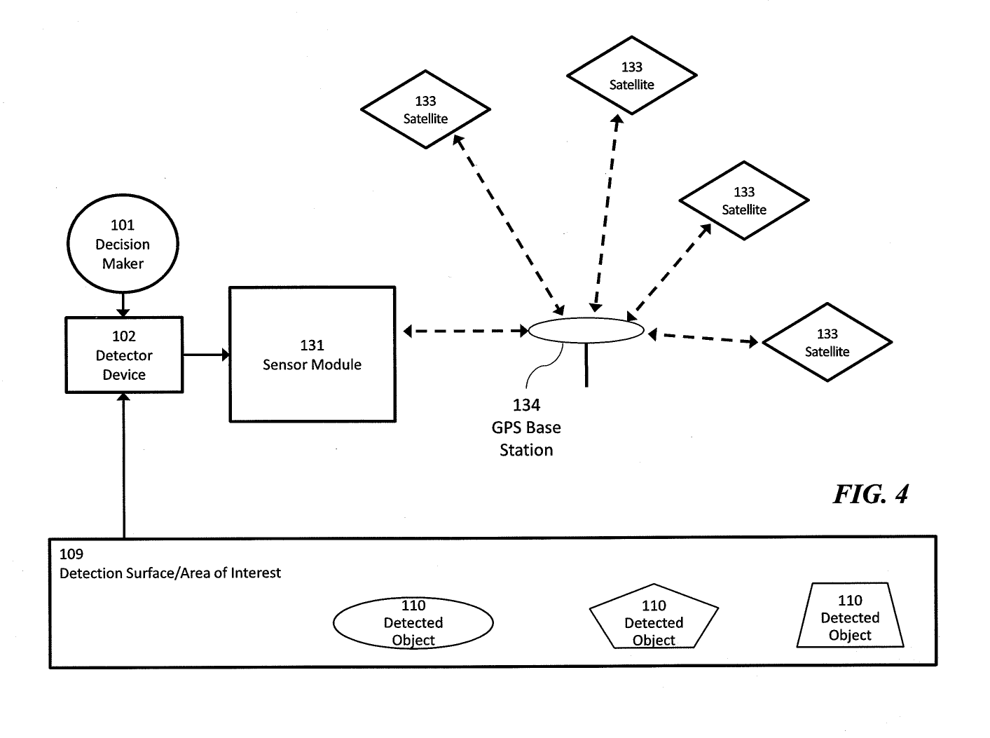

FIG. 4 is a block diagram of a system configured to use GPS-based position tracking for determining the relative position, orientation, motion, and heading of a sensing device with respect to a detection surface and with respect to the earth's coordinate frame in accordance with an embodiment of the present technology. Referring back to FIG. 2, in certain embodiments the system component 103 can also include a radio transceiver 119 that can be used in conjunction with a fixed external reference point base station 134 to determine 3D position, orientation, heading, and/or motion with respect to the detection surface 109 using satellite navigation techniques (e.g., Real Time Kinematic (RTK) GPS). Satellite navigation techniques may also be used to determine 3D position (latitude, longitude, altitude) and motion in the absolute coordinate frame.

It should be appreciated that a combination of one or methods described above may be used in concert to determine 3D position, orientation, heading, and/or motion of the sensing device 102 with respect to the detection surface 109. In addition, one or more of the methods described above may be used to determine 3D position, orientation, heading, and/or motion of the sensing device 102 with respect to the absolute coordinate frame.

The system component 103 can also include a computing unit 120 (e.g., a computer with a central processing unit, memory, input/output controller, etc.) that can be used to time synchronize (a) position estimation data (e.g., from the ultrasound transceiver 118, the radio transceiver 119, the gyroscope 116, the magnetometer 117, the accelerometer 115, the wireless data communication 114, and/or the optical array 113), (b) feedback from the sensing device 102, and (c) detection surface information from the optical array 113 and user input actions from the input device 112. In certain embodiments, the computing unit 120 also applies signal-processing operations on the raw data signal received from the sensing device 102. In other embodiments, the system component 103 can receive and process feedback signals from more than one sensing device. In other embodiments, the computing unit 120 performs machine learning, pattern recognition, or any other statistical analysis of the data from the sensing device 102 to provide assistive feedback about the nature of threats in the ground. Such feedback may include, but is not limited to, threat size, location, material (e.g., mostly plastic or non-metallic?), type (e.g., is it a piece of debris or an explosive?), and configuration (e.g., where is the estimated trigger point of the buried explosive?).

In certain embodiments of the technology, some of or all of the computations required for computing 3D position, motion, heading, and/or orientation can be performed using the computing device 120. In other embodiments, these computational operations can be performed (e.g., offloaded) to another device communicatively coupled thereto (e.g., the computing device 105 of FIG. 1 or servers operating in data network 130).

In further embodiments of the technology, at least a portion of the computations required for rendering a virtual representation of the detection surface can be performed on the computing unit 120, whereas in other embodiments these computational operations can be offloaded to other devices communicatively coupled thereto (e.g., the computing device 105 of FIG. 1 or servers operating in data network 130).

In still further embodiments of the technology, at least a portion of the computations for recording and rendering points of interests during investigation activity (e.g., indicated using the input device 112) can be performed using the computing unit 120, and in other embodiments these computational operations can be performed by devices communicatively coupled thereto (e.g., the computing device 105 of FIG. 1 or servers operating in data network 130).

Certain aspects of the present technology may take the form of computer-executable instructions, including routines executed by a controller or other data processor. In some embodiments, a controller or other data processor is specifically programmed, configured, and/or constructed to perform one or more of these computer-executable instructions. Furthermore, some aspects of the present technology may take the form of data (e.g., non-transitory data) stored or distributed on computer-readable media, including magnetic or optically readable and/or removable computer discs as well as media distributed electronically over networks (e.g., cloud storage data network 130 in FIG. 1). Accordingly, data structures and transmissions of data particular to aspects of the present technology are encompassed within the scope of the present technology. The present technology also encompasses methods of both programming computer-readable media to perform particular steps and executing the steps.

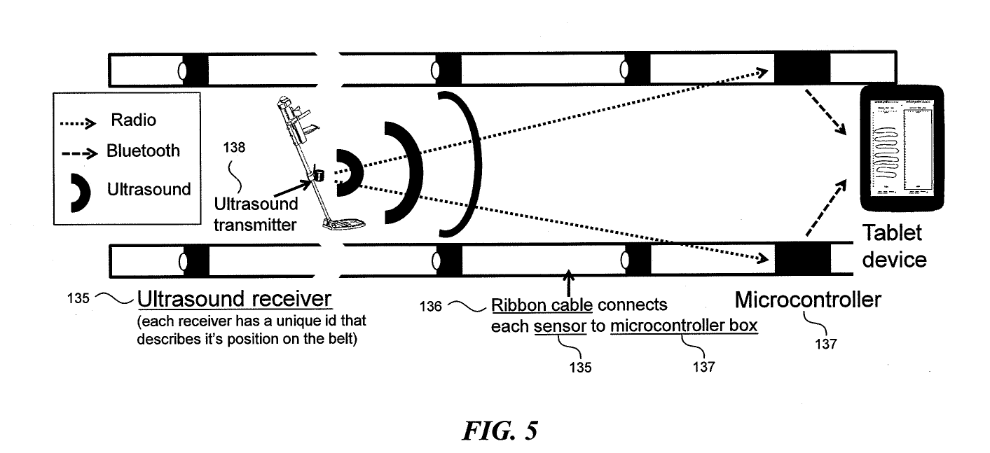

FIG. 5 is a schematic diagram of a system configured to use ultrasound-based position tracking for determining the relative position, orientation, motion, and heading of a sensing device with respect to a detection surface in accordance with an embodiment of the present technology. In an embodiment for supporting operator training, e.g., with dual-mode (GPR and MD) detectors and defused targets in outdoor conditions, the system utilizes a set of ultrasound receiver beacons 135 laid on the ground (e.g., in the form of a belt 136) and a rover, including an ultrasound-emitting array 138 along with a sensor such as a nine-degrees-of-freedom inertial measurement unit (9-DOF IMU) sensor, mounted on the detector. The rover is mounted on a pre-determined position on the detector shaft. In the illustrated embodiment, to determine the position of the detector head, the rover emits an ultrasound pulse, immediately followed by a radio message (containing IMU data) to the microcontrollers 137 on the belt 136. The microcontroller 137 on the belt 136 computes the time-of-flight to the external reference point beacons 135 and transmits these straight-line distance estimates along with inertial measurements over a Bluetooth connection to a tablet device. The tablet performs computations on this data in order to determine the 3D spatial position of the detector head (in relation to the belts 136) and then displays, e.g., color-coded line trajectories of the detector head's 3D motion. The trajectories are color-coded in order to convey information about metrics such as detector head height above the ground and speed. The tablet operator uses this visual information in order to assess operator sweep speed, area coverage and other target investigation techniques. The data captured and computed by the tablet can be saved on-device and also shared over a network connection.

From the foregoing, it will be appreciated that specific embodiments of the disclosure have been described herein for purposes of illustration, but that various modifications may be made without deviating from the spirit and scope of the disclosure. Aspects of the disclosure described in the context of particular embodiments may be combined or eliminated in other embodiments. Further, while advantages associated with certain embodiments of the disclosure have been described in the context of those embodiments, other embodiments may also exhibit such advantages, and not all embodiments need necessarily exhibit such advantages to fall within the scope of the disclosure. Accordingly, embodiments of the disclosure are not limited except as by the appended claims.

I/We claim:

1. A method in a computing system of mapping onto a virtual representation of a detection surface feedback from an above-surface mobile detector of objects below the detection surface, the method comprising:
receiving data characterizing a position and motion of the mobile detector from one or more of inertial sensors, a GPS receiver, ultrasound transducers, and optical sensors associated with the mobile detector;
determining, by the computing system and based on the received data, a pose of the mobile detector;
receiving information characterizing the detection surface from one or more imaging sensors associated with the mobile detector;
generating, by the computing system, a virtual representation of the detection surface based on the determined pose of the mobile detector and the received information characterizing the detection surface;
capturing feedback from the mobile detector regarding detection of an object below the detection surface at a certain time;
identifying a detected object location based on the captured feedback from the mobile detector and the determined pose of the mobile detector at the certain time; and
displaying a visualization of the identified detected object location integrated into the virtual representation of the detection surface.

2. The method of claim 1 wherein the mobile detector is a landmine or IED detector having a detector head, and wherein determining a pose of the mobile detector includes tracking the position and motion of the detector head.

3. The method of claim 1 wherein determining a pose of the mobile detector includes determining an orientation and heading of the mobile detector.

4. The method of claim 1 wherein determining a pose of the mobile detector includes determining a position of the mobile detector based on communication with external reference point satellites or ultrasound beacons.

5. The method of claim 1 wherein receiving information characterizing the detection surface from one or more imaging sensors includes receiving information from an infrared camera or a visible light camera.

6. The method of claim 1 wherein generating a virtual representation of the detection surface includes compiling recorded images to generate a two-dimensional or three-dimensional photographic or topological representation of the detection surface.

7. The method of claim 1 wherein displaying a visualization of the identified detected object location integrated into the virtual representation of the detection surface includes displaying a heat map, a contour map, a topographical map, or a two-dimensional or three-dimensional representation including photographic or infrared images.

8. The method of claim 1 wherein displaying a visualization of the identified detected object location includes displaying detector feedback using points, shapes, lines, or an icon to indicate a detected object or an edge or contour of a detected object.

9. The method of claim 1, further comprising:
identifying a detected object type, material, size, or configuration based on the captured feedback from the mobile detector; and
displaying a visualization of the identified detected object type, material, size, or configuration integrated into the virtual representation of the detection surface.

10. The method of claim 1, further comprising:
capturing user-defined temporal or spatial points of interest; and
displaying the captured user-defined temporal or spatial points of interest integrated into the virtual representation of the detection surface.

11. A system for mapping feedback from a mobile subsurface object detector onto a virtual representation of a detection surface, the system comprising:
one or more pose sensors, including—
one or more inertial sensors configured to sense the position, orientation, heading, or motion of the mobile subsurface object detector; and
an external reference point locator;
an optical sensor configured to have a field of view of the detection surface;
an input device configured to receive feedback from the mobile subsurface object detector;
a processor configured to visually integrate the feedback from the mobile subsurface object detector onto a virtual representation of the detection surface; and
a display device configured to display the virtual representation of the detection surface including the visually integrated feedback.

12. The system of claim 11 wherein the mobile subsurface object detector includes a metal detector or a ground-penetrating radar.

13. The system of claim 11:
wherein the one or more inertial sensors include at least one gyroscope, at least one accelerometer, and at least one magnetometer;
wherein the external reference point locator includes a GPS receiver, an ultrasound transducer, a laser rangefinder, or an infrared camera; and
wherein the optical sensor includes a camera or an infrared sensor.

14. The system of claim 11 wherein the input device is a microphone configured to detect acoustic feedback from the mobile subsurface object detector or recognize voice commands from a user.

15. The system of claim 11 wherein the input device includes a push button configured to allow a user of the mobile subsurface object detector to denote spatial or temporal points of interest.

16. The system of claim 11, further comprising a remote computing device configured to display the virtual representation of the detection surface including the visually integrated feedback to a remote user.

17. The system of claim 11, further comprising an unmanned aerial or ground vehicle configured to move the detector above the detection surface.

18. A system component for mapping sensor feedback from a detector of subsurface structure onto a virtual representation of a detection surface, the system component comprising:
a detector pose component configured to record a pose of the detector;
a detection surface component configured to record information about the detection surface;
a user input component configured to record user input from a user input device;
an object detection component configured to record detector feedback;
a processing component configured to create a virtual representation of the detection surface based on the recorded pose of the detector and information about the detection surface;
an object mapping component configured to map locations based on the recorded user input and detector feedback; and
a display component configured to visually display the mapped locations integrated into the virtual representation of the detection surface.

19. The system component of claim 18, further comprising an ultrasound or radio transceiver configured to determine a position, orientation, heading, or motion of the detector in relation to one or more external reference points.

20. The system component of claim 18 wherein the processing component is a computing device remote from the detector and operatively coupled via a wired or wireless data connection to at least one component associated with the detector.

21. The system component of claim 18 wherein the object detection component is configured to capture electrical, optical, or acoustic signals from the detector.

22. The system component of claim 18, further comprising a communication component configured to transmit the mapped locations or the virtual representation of the detection surface to a remote computing system.

23. The system component of claim 18 wherein:
the processing component is configured to create a virtual representation of the detection surface based on recorded poses of multiple detectors and information about the detection surface from multiple detectors; and
the object mapping component is configured to map locations based on recorded user input and detector feedback from multiple detectors.
